(19) United States
(12) Patent Application Publication
(10) Pub. No.: US 2008/0169930 A1
(43) Pub. Date: Jul. 17, 2008

(54) METHOD AND SYSTEM FOR MEASURING A USER'S LEVEL OF ATTENTION TO CONTENT

(75) Inventor: Dominic Saul Mallinson, Redwood City, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment Inc., Minato-Ku (JP)

(21) Appl. No.: 11/624,152

(22) Filed: Jan. 17, 2007

(51) Int. Cl. G08B 23/00

(52) U.S. Cl. 340/573.1

(57) ABSTRACT

A method for use with a media player includes playing an item of content for a user on the media player, wherein the media player includes one or more sensors configured to allow the user to interact with the media player, receiving information from at least one of the one or more sensors during the playing of at least a portion of the item of content; analyzing the received information, and forming at least an indication of the user's level of attention to the portion of the item of content based on the analysis of the received information. A storage medium storing a computer program executable by a processor based system causes the processor based system to execute similar steps. A system for use in playing media includes a media player portion and a processing portion.

### BACKGROUND OF THE INVENTION

1. Field of the Invention

Embodiments of the present invention relate generally to advertising, and more specifically to techniques for measuring the effectiveness of advertising.

2. Discussion of the Related Art

One traditional form of advertising is the television commercial. Such television commercials typically consist of brief advertising spots that range in length from a few seconds to several minutes. The commercials appear between shows and interrupt the shows at regular intervals. The goal of advertisers is to keep the viewer's attention focused on the commercial.

Advertising has also been used in video games. Such advertising often takes the form of advertisements that are inserted and placed on billboards, signs, etc., that are displayed in the scenes of the game.

It is with respect to these and other background information factors that the present invention has evolved.

### SUMMARY OF THE INVENTION

One embodiment provides a method for use with a media player, comprising: playing an item of content for a user on the media player, wherein the media player includes one or more sensors configured to allow the user to interact with the media player; receiving information from at least one of the one or more sensors during the playing of at least a portion of the item of content; analyzing the received information; and forming at least an indication of the user's level of attention to the portion of the item of content based on the analysis of the received information.

Another embodiment provides a storage medium storing a computer program executable by a processor based system, the computer program causing the processor based system to execute steps comprising: playing an item of content for a user on a media player, wherein the media player includes one or more sensors configured to allow the user to interact with the media player; receiving information from at least one of the one or more sensors during the playing of at least a portion of the item of content; analyzing the received information; and forming at least an indication of the user's level of attention to the portion of the item of content based on the analysis of the received information.

Another embodiment provides a system for use in playing media, comprising: a media player portion for playing an item of content for a user, wherein the media player portion includes one or more sensors configured to allow the user to interact with the media player; and a processing portion configured to receive information from at least one of the one or more sensors during the playing of at least a portion of the item of content, analyze the received information, and form at least an indication of the user's level of attention to the portion of the item of content based on the analysis of the received information.

A better understanding of the features and advantages of various embodiments of the present invention will be obtained by reference to the following detailed description and accompanying drawings which set forth an illustrative embodiment in which principles of embodiments of the invention are utilized.

### BRIEF DESCRIPTION OF THE DRAWINGS

The above and other aspects, features and advantages of embodiments of the present invention will be more apparent from the following more particular description thereof, presented in conjunction with the following drawings wherein:

FIG. 1 is a block diagram illustrating an example implementation in accordance with an embodiment of the present invention;

FIG. 2 is a flow diagram illustrating a method for use with a media player in accordance with an embodiment of the present invention;

FIG. 3 is a screen shot illustrating an example advertisement and stimulus in accordance with an embodiment of the present invention;

FIG. 4 is a timing diagram illustrating an example application of a method in accordance with an embodiment of the present invention; and

FIG. 5 is a block diagram illustrating a processor based system that may be used to run, implement and/or execute the methods and/or techniques shown and described herein in accordance with embodiments of the present invention.

### DETAILED DESCRIPTION

Traditionally, advertisements are typically broadcast and have no feedback mechanism. As such, there has been no easy way to know if an advertisement on television is actually watched or ignored. In the past, ratings and measures for the effectiveness of advertisements could only be conducted in rough statistical terms by selecting a representative group and monitoring them.

Embodiments of the present invention provide a method and/or system that may be used for measuring a user's level of attention to content, which may be used for measuring the effectiveness of advertising. Namely, in some embodiments an interactive networked device, such as an entertainment system or other media player, may be used to make measurements to help indicate if an advertisement was actually paid attention too by the user. Some embodiments also have the ability to monitor and/or measure the general usage patterns of a media player. For example, statistics may be gathered about how long and at what times the media player was used and which content (e.g. which games, movies, etc.) was being watched.

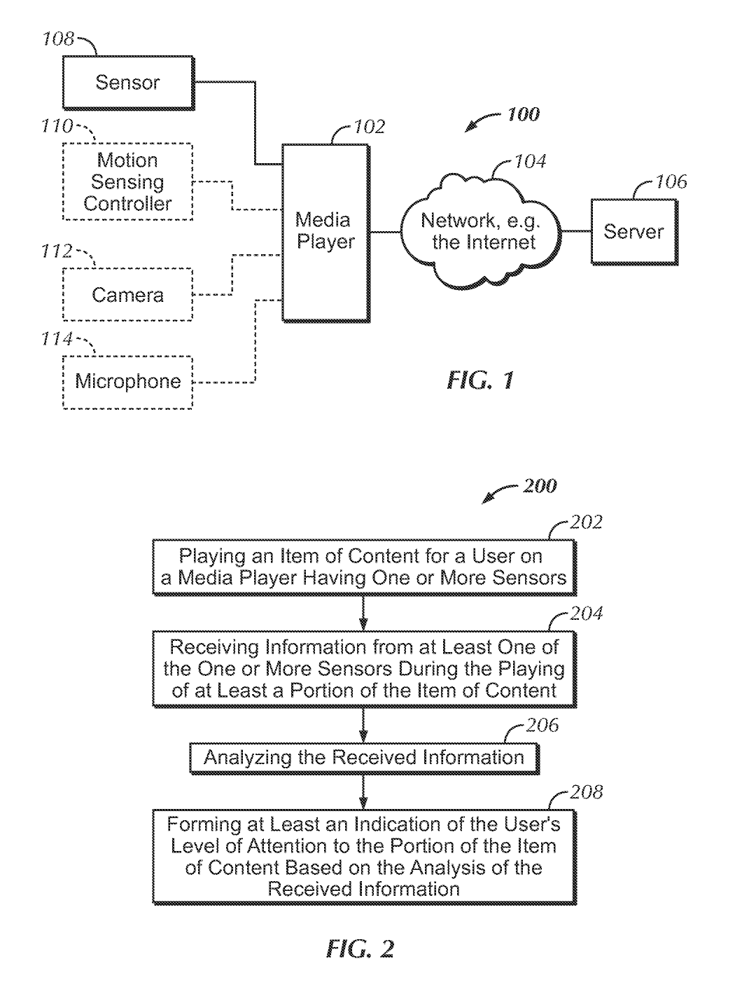

Referring to FIG. 1, there is illustrated a system 100 that operates in accordance with an embodiment of the present invention. The system 100 includes a media player 102. By way of example, the media player 102 may comprise an entertainment system, game console, game system, personal computer (PC), television (TV), handheld device, DVD player, digital video recorder (DVR), cable set-top box, stereo, CD player, audio player, radio, etc. In some embodiments the media player 102 may additionally comprise a networked device. As such, the media player 102 may be coupled to a network 104, such as the Internet. Other devices, servers, etc., may also be coupled to the network 104, such as for example the server 106.

At least one sensor 108 may be coupled to the media player 102. The sensor 108 may be configured to allow the user to interact with the media player 102. More than one such sensor may be coupled to the media player 102. For example, in some embodiments such sensors may comprise a motion sensing controller 110, a camera 112, and/or a microphone 114, as shown. Additional such sensors may comprise a keyboard, joystick, mouse, etc.

In some embodiments the motion sensing controller 110 may comprise a hand-held controller that has the ability to have its three-dimensional movements tracked. Such tracking may be performed in many different ways. For example, such tracking may be performed through inertial, video, acoustical, or infrared analysis. By way of example, in some embodiments the motion sensing controller 110 may comprise any of the type of controllers described in U.S. patent application Ser. No. 11/382,034, filed on May 6, 2006, entitled “SCHEME FOR DETECTING AND TRACKING USER MANIPULATION OF A GAME CONTROLLER BODY”, U.S. patent application Ser. No. 11/382,037, filed on May 6, 2006, entitled “SCHEME FOR TRANSLATING MOVEMENTS OF A HAND-HELD CONTROLLER INTO INPUTS FOR A SYSTEM”, U.S. patent application Ser. No. 11/382,043, filed on May 7, 2006, entitled “DETECTABLE AND TRACKABLE HAND-HELD CONTROLLER”, U.S. patent application Ser. No. 11/382,039, filed on May 7, 2006, entitled “METHOD FOR MAPPING MOVEMENTS OF A HAND-HELD CONTROLLER TO GAME COMMANDS”, U.S. patent application Ser. No. 11/382,259, filed on May 8, 2006, entitled “METHOD AND APPARATUS FOR USE IN DETERMINING LACK OF USER ACTIVITY IN RELATION TO A SYSTEM”, U.S. patent application Ser. No. 11/382,258, filed on May 8, 2006, entitled “METHOD AND APPARATUS FOR USE IN DETERMINING AN ACTIVITY LEVEL OF A USER IN RELATION TO A SYSTEM”, U.S. patent application Ser. No. 11/382,251, filed on May 8, 2006, entitled “HAND-HELD CONTROLLER HAVING DETECTABLE ELEMENTS FOR TRACKING PURPOSES,” U.S. patent application Ser. No. 11/536,559, filed Sep. 28, 2006, entitled “MAPPING MOVEMENTS OF A HAND-HELD CONTROLLER TO THE TWO-DIMENSIONAL IMAGE PLANE OF A DISPLAY SCREEN,” U.S. patent application Ser. No. 11/551,197, filed Oct. 19, 2006, entitled “CONTROLLER CONFIGURED TO TRACK USER'S LEVEL OF ANXIETY AND OTHER MENTAL AND PHYSICAL ATTRIBUTES,” and U.S. patent application Ser. No. 11/551,682, filed Oct. 20, 2006, entitled “GAME CONTROL USING THREE-DIMENSIONAL MOTIONS OF CONTROLLER,” the entire disclosures of which are all hereby incorporated herein by reference in there entirety.

In general, in some embodiments, the interactive capabilities of the media player 102 may be used to make measurements of how attentive the user is to an item of content, such as an advertisement. The information received from sensors such as the motion sensing controller 110, camera 112, and/or microphone 114, may be analyzed for the additional purpose of forming at least an indication of the user's level of attention to one or more portions the content being played.

For example, in some embodiments a camera may be the only sensor coupled to a device such as a PC, cable set-top box, network consumer electronic device, or other device. The information received from the camera may be used to form at least an indication of the user's level of attention to one or more portions of content. For example, the camera may comprise a webcam that is coupled to a PC, and the information received from the webcam may be used to form at least an indication of the user's level of attention to Internet advertisements such as banner advertisements. In another example, the camera may comprise a webcam that is coupled to a cable set-top box, and the information received from the webcam may be used to form at least an indication of the user's level of attention to cable TV advertisements or programs.

Referring to FIG. 2, there is illustrated a method 200 that operates in accordance with an embodiment of the present invention. The method 200 may be used with a media player such as, for example, any of those described above.

The method 200 begins in step 202 where an item of content is played for a user on a media player, which includes one or more sensors configured to allow the user to interact with the media player. The one or more sensors may comprise any type of sensor, such as for example any of those described above.

In step 204 information is received from at least one of the one or more sensors during the playing of at least a portion of the item of content. The item of content may comprise any type of content. For example, in some embodiments the item of content may comprise a movie, TV show, advertisement, game, video program, audio program, etc. Similarly, in some embodiments the portion of the item of content may also comprise any of those types of content or any portions thereof.

By way of example, in some embodiments, the information received from the at least one of the one or more sensors may comprise any type of information or data normally generated by the sensor. For example, in some embodiments, a motion sensing controller may generate position information, a camera may generate image information, and a microphone may generate audio information.

The received information is analyzed in step 206, and in step 208 at least an indication of the user's level of attention to the portion of the item of content is formed based on the analysis of the received information.

An example application of the method 200 will now be described. This example relates to determining a user's level of attention to an in game advertising message. Specifically, a game console may be connected to an always on network. The game console may include a wireless motion sensing controller, camera, microphone, and/or any other type of sensor. In some embodiments, the user logs into the network platform and downloads a promotional mini game or any other game or program sponsored by an advertiser. The game may be free, but the user may be required to watch an advertisement before playing the game. In this example, the advertisement may take a form similar to a typical thirty-second video. However, in some embodiments there may be some difference of this advertisement when compared to a normal television advertisement.

For example, in some embodiments the behavior of a motion sensing controller may be used as one measure of the user's level of attention. Namely, as the advertisement plays the media player measures the movement of the controller. In some embodiments part of the analysis may involve a determination that if there is no motion during the majority of the advertisement, then one plausible assumption is that the user has put the controller down somewhere. This does not necessarily mean that the user is not paying attention to the advertisement, but it is one simple measure.

Assuming that the user does keep hold of the controller during the advertisement, then the analysis may further involve correlating the motion of the controller to the advertisement. One way to do this in some embodiments is to introduce some stimulus into the advertisement which will cause some physical reaction from the user. For example, there may be a sudden shock, flash and/or noise. This may cause the user to react and the resulting motion can be recorded from the controller and correlated in time with the advertisement.

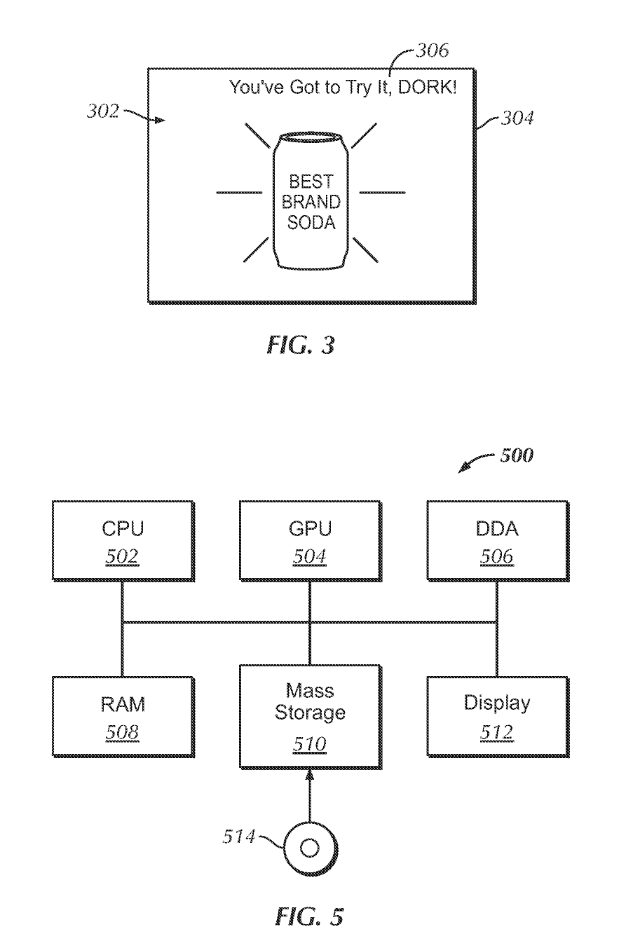

A more subtle response would be to elicit a laugh from the user in response in the advertisement which would normally cause some corresponding motion of the controller. FIG. 3 illustrates one such example in accordance with an embodiment of the present invention. Specifically, an advertisement 302 for “Best Brand Soda” is displayed on a display 304. A slogan 306 is also displayed, which reads “You've Got to Try It, DORK!”. By using the word “DORK!”, the slogan 306 is intended to elicit a laugh or other reaction from the user. It is believed that such laugh or other reaction from the user may normally cause some corresponding motion of the controller, which could then me measured and correlated in time with the advertisement. In some embodiments advanced pattern matching techniques may be employed using test groups of people holding the controller in a normal home environment and measure the patterns of those who are watching the advertisement versus those who are not paying attention. In some embodiments the stimulus may be intended to elicit other reactions from the users, such as for example movement of one or both of the user's arms.

As another example, in some embodiments the information received from a camera or other photo or video capture device may be used as another measure of the user's level of attention. Namely, a camera or other photo or video capture device may be set on top or close to the media player. If the media player comprises an entertainment system, computer, or the like having a display device, then the camera or other photo or video capture device may be set close to the display. Consequently, the player will look at the camera when he or she looks at the display.

As the advertisement plays, the camera will capture one or more images of the player. In some embodiments, face recognition techniques may be used to measure the probability that the player is watching the advertisement. For example, face recognition techniques may be used to determine if the player's face is looking towards the display during the advertisement, as opposed to looking away or even walking out the room. In some embodiments, with sufficient resolution and lighting, the camera may correlate facial expression to the advertisement. For example, a “laugh out loud” or “smile” response may be measured and correlated with the advertisement.

As another example, in some embodiments the information received from a microphone or other audio capture device may be used as another measure of the user's level of attention. Namely, the media player may include a microphone or other audio capture device. For example, if the media player includes a camera, there may be a microphone associated with the camera. Some cameras may include an advanced microphone array. In this way, any audible response from the user may be correlated with the advertisement. The “laugh” response from the user is one measure. In some embodiments an “Oooh” or “Ouch” response from the user may be solicited by inserting an appropriate stimulus in the advertisement.

In some embodiments the user's level of attention may be determined based on a multi-modal measurement. For example, the controller motion, camera video, and microphone sensors may be used together to enhance the accuracy of the measurement of any correlation of the user's response with the stimulus from the advertisement.

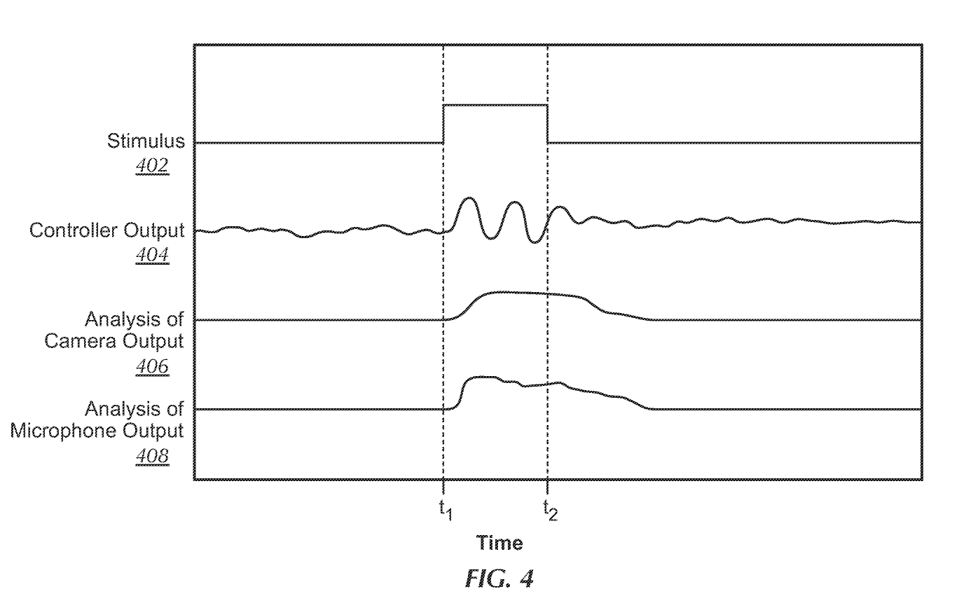

Thus, in some embodiments there will be a time duration for the viewing of the advertisement and some measurable stimulus-response which can be time correlated to provide evidence of attention to the advertisement. FIG. 4 illustrates an example of such correlation in accordance with an embodiment of the present invention. As shown, a stimulus 402 in the advertisement or other program begins at time t₁ and continues until time t₂. Again, the stimulus 402 may comprise anything that is intended to elicit a laugh, shout, smile, movement, reaction, etc., from the user. In some embodiments in-game advertising may be employed where an in-game bill-board might elicit a response at a particular known moment in time.

Part of the correlation analysis may involve observing the motion sensing controller output 404 during or around the time period t₁ to t₂. As shown, the activity of the controller increases during this time period, which may indicate that the user paid attention to the stimulus part of the advertisement.

Similarly, in some embodiments the correlation analysis may involve observing an analysis of a camera output 406 during or around the time period t₁ to t₂. For example, the camera output may be continually analyzed during the advertisement or other program to detect a “smile” or “look away” by the user. A positive detection of a “smile” may be indicated by the output 406 going high during the time period t₁ to t₂ as shown. This may indicate that the user paid attention to the stimulus part of the advertisement. Or, a positive detection of a “look away” may be indicated by the output 406 going high during the time period t₁ to t₂ as shown. This may indicate that the user did not pay attention to the stimulus part of the advertisement.

And in some embodiments the correlation analysis may involve observing an analysis of a microphone output 408 during or around the time period t₁ to t₂. For example, the microphone output may be continually analyzed during the advertisement or other program to detect a “laugh”, “shout”, or similar vocal response by the user. A positive detection of such response may be indicated by the output 408 going high during the time period t₁ to t₂ as shown. Again, this may indicate that the user paid attention to the stimulus part of the advertisement.

In some embodiments the analysis and correlation of the information received form the sensors may be performed in the media player itself. And in some embodiments the analysis and correlation of the information received form the sensors may be performed in a separate device or system. For example, the information received from the sensors may be sent over the network 104 (FIG. 1) so that the analysis and correlation of the information may be performed elsewhere, such as in the server 106. Thus, a system for use in playing media in accordance with some embodiments of the present invention may comprise a media player portion and a processing portion that may be all included in a single device or system or spread across two or more devices or systems.

In some embodiments an end result is to form at least an indication of the user's level of attention to the portion of the item of content based on the analysis and correlation of the information received from the sensors. Such end result may be a confidence measure which is a percentage certainty that the user was actually paying attention to the advertisement. In some embodiments the end result does not have to comprise a precise determination of the user's level of attention, but rather may comprise an indication, estimate or “best guess” of the user's level of attention.

In some embodiments the end result indication or other measure may then be sent over a network and statistically collected to present the advertiser with a measurement of how much attention was paid to the advertisement. This may be valuable information to the advertiser.

The above examples described the case of video advertisements, but it should be well understood that the technique may also be used for other forms of advertisements. For example, in some embodiments the advertisements could take the form of purely audio advertising. In some embodiments Internet radio stations may be augmented to monitor the responses to web browser advertisements by using this technology in an entertainment system web browser.

Games are not the only place to advertise and are thus not the only place where the teachings of the present invention may be employed. In some embodiments music videos or movie trailers may be downloaded and advertisements can be included therein. The media player may measure the response and report back. In some embodiments the technology may be integrated into Blu-ray and/or DVD movie playback software. This may be used to measure not only in-movie product placement, but also to give the publishers information on how many people watch the special features on a DVD or how many watch the trailers for other movies. No special sensors are needed because the sensors normally used with the media player are used. Similarly, in some embodiments, without any special sensors, statistics may be gathered about how long people play certain games or otherwise use their entertainment system or the like. The data may be sold to publishers to indicate the game playing or movie watching habits of consumers.

In some embodiments the techniques described herein may be enhanced with volunteer target groups. Just as with conventional ratings, a demographically representative set of volunteers can be chosen and closely monitored. In this way, their response can be tied directly to their demographic. In some embodiments, video of the user may be recorded/monitored to see how they reacted to the advertisement. Questionnaires may be sent to the user as a follow up.

Thus, a media player having one or more sensors may be used to sense the user's attention using any of the methods described herein. For example, in some embodiments a computer with a camera may be used for web tracking of advertisements. As another example, a TV may be equipped with a camera and the camera may be used to detect user attention as well as for remote control user gesture tracking to control the device. In this way media players having one or more sensors may be used to determine user attention to advertisements and/or other content. And any combination of sensors may be used, such as one sensor or two or more sensors combined. For example, a camera and microphone may be combined, or a camera and controller, or a microphone and controller, or a camera, microphone and controller, etc. In some embodiments the media player may include network connectivity so that information received from the sensors and/or the indication of the user's level of attention may be sent over the network.

The methods and techniques described herein may be utilized, implemented and/or run on many different types of computers, graphics workstations, televisions, entertainment systems, video game systems, DVD players, DVRs, media players, home servers, video game consoles, and the like. Referring to FIG. 5, there is illustrated a system 500 that may be used for any such implementations. For example, any of the media players, systems, and/or servers described herein may include all or one or more portions of the system 500. However, the use of the system 500 or any portion thereof is certainly not required.

By way of example, the system 500 may include, but is not required to include, a central processing unit (CPU) 502, a graphics processing unit (GPU) 504, digital differential analysis (DDA) hardware 506, a random access memory (RAM) 508, and a mass storage unit 510, such as a disk drive. The system 500 may be coupled to, or integrated with, a display 512, such as for example any type of display, including any of the types of displays mentioned herein. The system 500 comprises an example of a processor based system.

The CPU 502 and/or GPU 504 may be used to execute or assist in executing the steps of the methods and techniques described herein, and various program content and images may be rendered on the display 512. Removable storage media 514 may optionally be used with the mass storage unit 510, which may be used for storing code that implements the methods and techniques described herein. However, any of the storage devices, such as the RAM 508 or mass storage unit 510, may be used for storing such code. Either all or a portion of the system 500 may be embodied in any type of device, such as for example a television, computer, video game console or system, or any other type of device, including any type of device mentioned herein.

While the invention herein disclosed has been described by means of specific embodiments and applications thereof, numerous modifications and variations could be made thereto by those skilled in the art without departing from the scope of the invention set forth in the claims.

What is claimed is:

1. A method for use with a media player, comprising:
playing an item of content for a user on the media player, wherein the media player includes one or more sensors configured to allow the user to interact with the media player;
receiving information from at least one of the one or more sensors during the playing of at least a portion of the item of content;
analyzing the received information; and
forming at least an indication of the user's level of attention to the portion of the item of content based on the analysis of the received information.

2. A method in accordance with claim 1, wherein the item of content comprises an advertisement.

3. A method in accordance with claim 1, further comprising:
estimating an effectiveness of an advertisement based on the indication of the user's level of attention to the portion of the item of content.

4. A method in accordance with claim 1, wherein the step of analyzing comprises:
correlating the received information with the portion of the item of content.

5. A method in accordance with claim 1, wherein the portion of the item of content comprises a stimulus that is intended to cause a physical reaction from the user.

6. A method in accordance with claim 5, wherein the stimulus is intended to elicit laughter from the user.

7. A method in accordance with claim 5, wherein the stimulus is intended to elicit movement of one or both of the user's arms.

8. A method in accordance with claim 1, wherein the media player comprises a networked device.

9. A method in accordance with claim 1, further comprising:
sending the received information over a network.

10. A method in accordance with claim 1, wherein the one or more sensors comprises a motion sensing controller.

11. A method in accordance with claim 1, wherein the one or more sensors comprises a camera.

12. A method in accordance with claim 1, wherein the one or more sensors comprises a microphone.

13. A storage medium storing a computer program executable by a processor based system, the computer program causing the processor based system to execute steps comprising:
playing an item of content for a user on a media player, wherein the media player includes one or more sensors configured to allow the user to interact with the media player;
receiving information from at least one of the one or more sensors during the playing of at least a portion of the item of content;
analyzing the received information; and
forming at least an indication of the user's level of attention to the portion of the item of content based on the analysis of the received information.

14. A storage medium in accordance with claim 13, wherein the item of content comprises an advertisement.

15. A storage medium in accordance with claim 13, wherein the computer program causes the processor based system to further execute a step comprising:
estimating an effectiveness of an advertisement based on the indication of the user's level of attention to the portion of the item of content.

16. A storage medium in accordance with claim 13, wherein the step of analyzing comprises:
correlating the received information with the portion of the item of content.

17. A storage medium in accordance with claim 13, wherein the portion of the item of content comprises a stimulus that is intended to cause a physical reaction from the user.

18. A storage medium in accordance with claim 17, wherein the stimulus is intended to elicit laughter from the user.

19. A storage medium in accordance with claim 17, wherein the stimulus is intended to elicit movement of one or both of the user's arms.

20. A storage medium in accordance with claim 13, wherein the media player comprises a networked device.

21. A storage medium in accordance with claim 13, wherein the computer program causes the processor based system to further execute a step comprising:
sending the received information over a network.

22. A storage medium in accordance with claim 13, wherein the one or more sensors comprises a motion sensing controller.

23. A storage medium in accordance with claim 13, wherein the one or more sensors comprises a camera.

24. A storage medium in accordance with claim 1, wherein the one or more sensors comprises a microphone.

25. A system for use in playing media, comprising:
a media player portion for playing an item of content for a user, wherein the media player portion includes one or more sensors configured to allow the user to interact with the media player; and
a processing portion configured to receive information from at least one of the one or more sensors during the playing of at least a portion of the item of content, analyze the received information, and form at least an indication of the user's level of attention to the portion of the item of content based on the analysis of the received information.

26. A system in accordance with claim 25, wherein the item of content comprises an advertisement.

27. A system in accordance with claim 25, wherein the processing portion is further configured to estimate an effectiveness of an advertisement based on the indication of the user's level of attention to the portion of the item of content.

28. A system in accordance with claim 25, wherein the step of analyzing comprises:
correlating the received information with the portion of the item of content.

29. A system in accordance with claim 25, wherein the portion of the item of content comprises a stimulus that is intended to cause a physical reaction from the user.

30. A system in accordance with claim 29, wherein the stimulus is intended to elicit laughter from the user.

31. A system in accordance with claim 29, wherein the stimulus is intended to elicit movement of one or both of the user's arms.

32. A system in accordance with claim 25, wherein the media player portion comprises a networked device.

33. A system in accordance with claim 25, wherein the processing portion is further configured to send the received information over a network.

34. A system in accordance with claim 25, wherein the one or more sensors comprises a motion sensing controller.

35. A system in accordance with claim 25, wherein the one or more sensors comprises a camera.

36. A system in accordance with claim 25, wherein the one or more sensors comprises a microphone.
